(19) United States
(12) Patent Application Publication
(10) Pub. No.: US 2018/0005424 A1
(43) Pub. Date: Jan. 4, 2018

(54) DISPLAY CONTROL METHOD AND DEVICE

(71) Applicant: FUJITSU LIMITED, Kawasaki-shi (JP)

(72) Inventors: Koichiro NIINUMA, Kawasaki (JP); Toshiyuki YOSHITAKE, Kawasaki (JP); Tetsuya YAMAOKA, Kawasaki (JP); Masafumi TADA, Setagaya (JP)

(73) Assignee: FUJITSU LIMITED, Kawasaki-shi (JP)

(21) Appl. No.: 15/596,410

(22) Filed: May 16, 2017

(30) Foreign Application Priority Data
Jun. 30, 2016 (JP) 2016-130209

(51) Int. Cl. G06T 11/60; G06T 19/00; G06Q 20/10

(52) U.S. Cl. CPC G06T 11/60; G06T 19/006; G06Q 20/1085

(57) ABSTRACT

A method includes detecting a plurality of reference objects from an image, acquiring a plurality of contents, virtually arranging the plurality of contents based on position information of each of the plurality of contents, determining whether an overlap occurs between display regions of at least some contents among the plurality of contents virtually arranged, when the overlap occurs, changing at least one of a display size and a position of the at least some contents overlapping each other to remove the overlap, generating display data for displaying another image including the plurality of contents based on at least one of the changed display size and the changed position of the at least some contents, and the position information of contents other than the at least some contents, and controlling a display to display the another image based on the display data.

### CROSS-REFERENCE TO RELATED APPLICATION

This application is based upon and claims the benefit of priority of the prior Japanese Patent Application No. 2016-130209, filed on Jun. 30, 2016, the entire contents of which are incorporated herein by reference.

### FIELD

The embodiments discussed herein are related to display control.

### BACKGROUND

In the related art product designing, design evaluation is performed by using mock-ups which are similar to products being designed. Mock-ups are models having appearances made similar to those of products. However, producing such mock-ups requests hours and costs.

The related arts are disclosed in Japanese Laid-open Patent Publication No. 2007-272575, Japanese Laid-open Patent Publication No. 2006-126936, and Japanese Laid-open Patent Publication No. 2009-104249, for example.

### SUMMARY

According to an aspect of the invention, a method includes detecting a plurality of reference objects from an image, specifying identification information corresponding to each of the plurality of reference objects, acquiring a plurality of contents corresponding to the respective identification information, virtually arranging the plurality of contents based on position information of each of the plurality of contents, the position information being set with reference to the plurality of reference objects respectively, determining whether an overlap occurs between display regions of at least some contents among the plurality of contents virtually arranged, when the overlap occurs, changing at least one of a display size and a position of the at least some contents overlapping each other to remove the overlap, generating display data for displaying another image including the plurality of contents based on at least one of the changed display size and the changed position of the at least some contents, and the position information of contents other than the at least some contents, and controlling a display to display the another image based on the display data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of the configuration of an evaluation system;

FIG. 2 is a diagram illustrating an example of the functional configuration of an HMD;

FIG. 3 is a diagram illustrating an example of the functional configuration of a display control apparatus;

FIG. 4 is a diagram illustrating an example of the data configuration of a content information table;

FIG. 5 is a diagram illustrating an example of the data configuration of content-related information;

FIG. 6 is a diagram illustrating an example of recognition of overlay targets;

FIG. 7 is a diagram illustrating an example of overlay of an image of a component that responds to touch operation;

FIG. 8 is a diagram illustrating an example of display of AR contents;

FIG. 9 is a diagram illustrating another example of display of AR contents;

FIG. 10 is a diagram illustrating still another example of display of AR contents;

FIG. 11 is a diagram illustrating still another example of display of AR contents;

FIG. 12 is a diagram illustrating an example of a processing flow to evaluate design usability;

FIG. 13 is a diagram illustrating an example of the processing flow to evaluate design usability;

FIG. 14 is a diagram illustrating an example of the processing flow to evaluate design usability;

FIG. 15 is a flowchart illustrating an example of the procedure of a display control process; and

FIG. 16 is a diagram illustrating an example of a computer executing a display control program.

### DESCRIPTION OF EMBODIMENTS

Although mock-ups provide the feeling of using an actual product, the designs thereof are fixed. To improve the designs, the mock-ups request to be remade, thus requesting a lot of time.

According to an aspect, the technique disclosed in embodiments is to provide display control capable of changing appearance of a mock-up being displayed in accordance with varying arrangement of real components.

Hereinafter, a description is given of embodiments of a display control program, a display control method, and a display control apparatus according to the embodiments with reference to the drawings. The embodiments are not limiting. The embodiments may be properly combined with no conflict between the processes.

### Embodiment 1

[System Configuration]

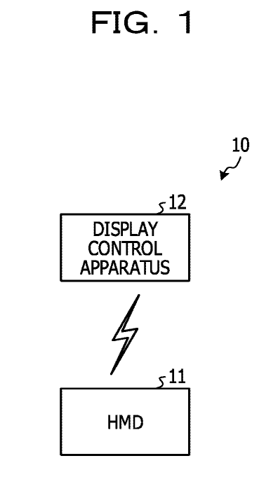

First, an example of an evaluation system that evaluates a product design using an augmented reality (AR) technique is described. In image processing using AR technique, a virtual AR content is overlaid on an image captured by a camera. By overlaying AR contents on an image in such a manner, various information may be additionally displayed in the captured image. FIG. 1 is a diagram illustrating an example of the configuration of the evaluation system. An evaluation system 10 is an AR system providing augmented reality. The evaluation system 10 includes a head mounted display (hereinafter, also referred to as an HMD) 11 and a display control apparatus 12. The HMD 11 and display control apparatus 12 are connected one to one wirelessly, for example. The HMD 11 functions as a display unit of the display control apparatus 12. FIG. 1 illustrates a pair of the HMD 11 and display control apparatus 12 as an example. However, the number of pairs of the HMD 11 and display control apparatus 12 is not limited. The evaluation system 10 may include any number of pairs of the HMD 11 and display control apparatus 12.

The HMD 11 and display control apparatus 12 are connected to communicate with each other by a wireless local area network (LAN), such as Wi-Fi Direct (registered trademark). The HMD 11 and display control apparatus 12 may be connected by wiring.

The HMD 11 is worn by a user together with the display control apparatus 12 and displays a screen based on image data transmitted from the display control apparatus 12. The HMD 11 may be a monocular see-through HMD, for example. The HMD 11 may be one selected from various types of HMDs such as binocular or immersive HMDs. The HMD 11 includes a camera as an example of an image capture device. The HMD 11 acquires an image by the camera. The HMD 11 transmits image data of the captured image to the display control apparatus 12. The HMD 11 displays an image based on the image data received from the display control apparatus 12 on a display unit.

The display control apparatus 12 is an information processing apparatus worn or operated by a user and may be a portable information processing apparatus such as a tablet terminal or a smartphone or a computer. The display control apparatus 12 stores data of various AR contents. The data of various AR contents may be downloaded from a server and stored in the display control apparatus 12 or may be stored in the display control apparatus 12 through a storage medium or the like. The display control apparatus 12 detects reference objects in the captured image received from the HMD 11. The reference objects may be marks serving as references to specify the positions where AR contents are to be displayed, such as AR markers or quick response (QR) codes (registered trademark). The reference objects may also be objects within the captured image, such as an object of a particular color or a particular pattern. In the first embodiment, the reference objects are AR markers. When the captured image includes AR markers, the display control apparatus 12 overlays (synthesizes) AR contents corresponding to the AR markers on the captured image. The display control apparatus 12 transmits an image where the AR contents are overlaid on the captured image to the HMD 11.

[Configuration of Head Mounted Display (HMD)]

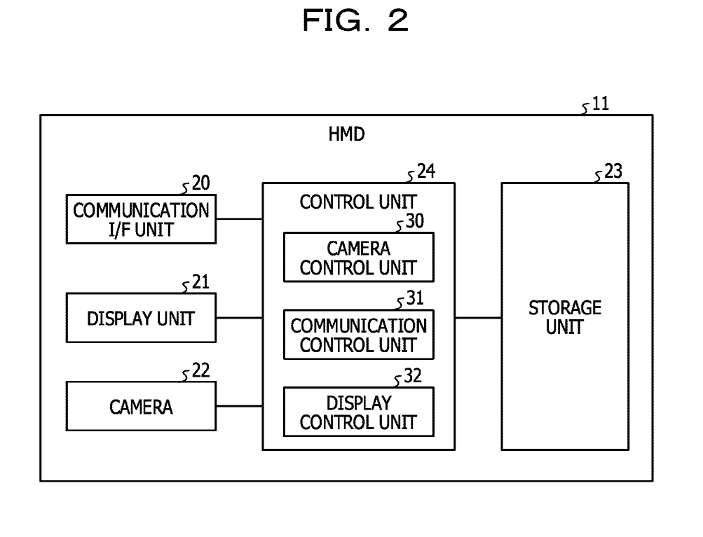

Next, the configuration of each apparatus is described. First, the configuration of the HMD 11 is described. FIG. 2 is a diagram illustrating an example of the functional configuration of the HMD 11. The HMD 11 includes a communication interface (I/F) unit 20, a display unit 21, a camera 22, a storage unit 23, and a control unit 24. The HMD 11 may include another device in addition to the aforementioned units.

The communication I/F unit 20 is an interface controlling communication with another apparatus. The communication I/F unit 20 exchanges various types of information with another apparatus through wireless communication. For example, the communication I/F unit 20 transmits image data of an image captured by the camera 22, to the display control apparatus 12. The communication I/F unit 20 receives instruction information representing an instruction to capture an image or image data for display, from the display control apparatus 12.

The display unit 21 is a device to display various types of information. The display unit 21 is provided on the HMD 11 in such a manner as to face the user's eyes when the user wears the HMD 11. The display unit 21 displays various types of information under control of the control unit 24. For example, the display unit 21 displays an image transmitted from the display control apparatus 12. In the display unit 21, the lens section is transmissive so that the user wearing the HMD 11 is allowed to see the external reality environment.

The camera 22 is a device which captures an image using an image pick-up device such as a charge coupled device (CCD) or a complementary metal oxide semiconductor (CMOS). The camera 22 is provided on the HMD 11 in such a manner as to be directed forward of the user wearing the HMD 11 and is configured to capture the forward view of the user wearing the HMD 11. The camera 22 captures an image and outputs image data of the captured image under control of the control unit 24.

The storage unit 23 is a storage device storing various types of information. The storage unit 23 is a data-rewritable semiconductor memory such as a random access memory (RAM), a flash memory, or a non-volatile static random access memory (NVSRAM). The storage unit 23 may be a storage device such as a hard disk, a solid state drive (SSD), or an optical disk.

The storage unit 23 stores a control program executed in the control unit 24 and various types of programs. The storage unit 23 further stores various types of data used in the programs executed in the control unit 24.

The control unit 24 is a device controlling the HMD 11. The control unit 24 may employ an electronic circuit such as a central processing unit (CPU) or a micro-processing unit (MPU) or an integrated circuit such as an application specific integrated circuit (ASIC) or a field programmable gate array (FPGA). The control unit 24 includes an internal memory storing programs that prescribe various processing procedures and control data and uses the programs and data stored in the internal memory to execute various processes.

The control unit 24 functions as various types of processing units when various programs operate. The control unit 24 includes a camera control unit 30, a communication control unit 31, and a display control unit 32, for example.

The camera control unit 30 controls the camera 22 for image capture. The camera control unit 30 captures an image at a predetermined frame rate through the camera 22 in accordance with the instruction information which is received from the display control apparatus 12 and instructs image capture, for example.

The communication control unit 31 controls exchange of various types of information. The communication control unit 31 transmits image data of an image captured by the camera 22 to the display control apparatus 12, for example. The communication control unit 31 receives image data for display, from the display control apparatus 12.

The display control unit 32 controls display of various types of information on the display unit 21. The display control unit 32 makes a control to display an image on the display unit 21 based on the image data received from the display control apparatus 12, for example.

[Configuration of Display Control Apparatus]

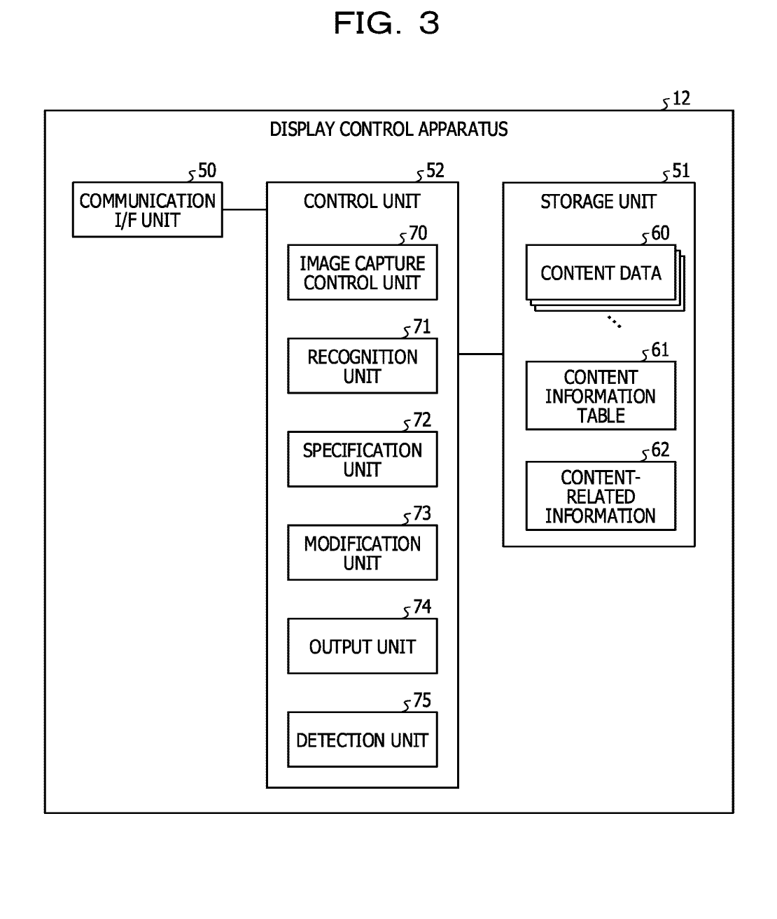

Next, the configuration of the display control apparatus 12 is described. FIG. 3 is a diagram illustrating an example of the functional configuration of the display control apparatus 12. As illustrated in FIG. 3, the display control apparatus 12 includes a communication I/F unit 50, a storage unit 51, and a control unit 52. The display control apparatus 12 may include another device included in a portable information processing apparatus or a computer in addition to the aforementioned units.

The communication I/F unit 50 is an interface controlling communication with another device. The communication I/F unit 50 exchanges various types of information with the HMD 11 through wireless communication. The communication I/F unit 50 receives image data of an image captured by the camera 22, from the HMD 11, for example. The communication I/F unit 50 transmits image data for display to the HMD 11.

The storage unit 51 is a storage device such as a hard disk, an SSD, or an optical disk. The storage unit 51 may be a data-rewritable semiconductor memory, such as a RAM, a flash memory, or an NVSRAM.

The storage unit 51 stores an operating system (OS) and various types of programs executed in the control unit 52. The storage unit 51 stores programs for implementing various types of processes including a later-described display control process, for example. The storage unit 51 further stores various types of data used in programs executed in the control unit 52. The storage unit 51 stores content data 60, a content information table 61, and content-related information 62, for example.

The content data 60 is data storing data of AR contents. The content data 60 includes image data of an image of a body constituting a product being designed and image data of images of various components constituting the product, for example. The content data 60 includes image data of an image of the body constituting the product and image data of images of components of units constituting a function serving as an interface with the user, such as an operation unit and a display unit mounted on the product. The content data 60 may include 3D data obtained by designing the body and components of the product. The content data 60 may also be data representing surface profiles of the body and components obtained based on the 3D data. The content data 60 may be polygon data representing the surface profiles of the body and components, for example.

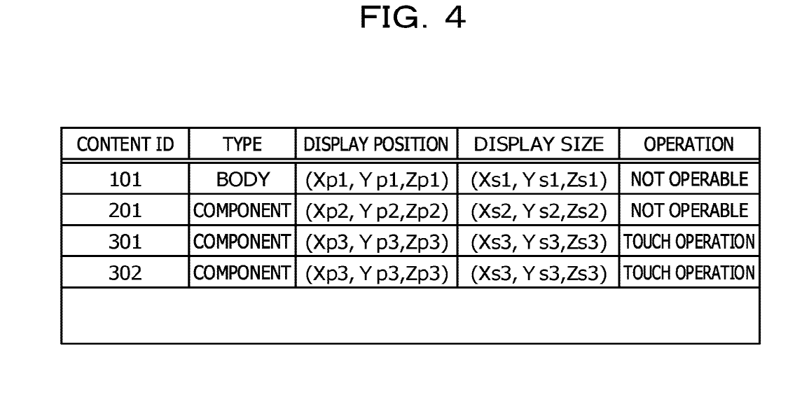

The content information table 61 includes data storing information concerning AR contents of the content data 60. In the content information table 61, the identification information of AR contents of the content data 60, types, and information concerning display styles are registered, for example. FIG. 4 is a diagram illustrating an example of the data configuration of the content information table 61. As illustrated in FIG. 4, the fields of the content information table 61 include items such as content IDs, types, display positions, display sizes, and operations. The items of the content information table 61 illustrated in FIG. 4 are illustrated by way of example, and the content information table 61 may include another item.

The fields for content IDs are regions storing identification information that identifies respective AR contents of the content data 60. The AR contents of the content data 60 are given content IDs as the identification information. The fields for content IDs store content IDs of AR contents of the content data 60. The fields for types are regions storing types indicating what kind of element type the AR content of each content IDs in the product being designed. In the first embodiment, the type of each AR content is a body constituting the product or a component provided on the body. The fields for types store whether each AR content is the body constituting the product being designed or the component provided on the body. The fields for display positions are regions storing data of the display position of each AR content based on the corresponding reference object. The fields for display positions store coordinates in the x, y, and z directions that indicate the predetermined position of each AR content based on the position of the corresponding reference object. The fields for display sizes are regions storing data of the display size of each AR content based on the corresponding reference object. The fields for display sizes store magnifications in the x, y, and z directions of each AR content based on the size of the corresponding reference object. The fields for operation are regions storing the type of operation that the AR content of each content ID responds to. In the first embodiment, AR contents of some components provided on the body are set to a type responding touch operation. The fields for operation of AR contents that respond to touch operation store “touch operation” while the fields for operation of AR contents that do not respond to any operation store “not operable”. In the example of FIG. 4, the AR content of a content ID of 101 is a body. The display position and display size thereof are (Xp1, Yp1, Zp1) and (Xs1, Ys1, Zs1), respectively. The AR content of a content ID of 101 do not respond to touch operation. The AR content of a content ID of 301 is a component. The display position and display size thereof are (Xp3, Yp3, Zp3) and (Xs3, Ys3, Zs3), respectively. The AR content of a content ID of 301 responds to touch operation.

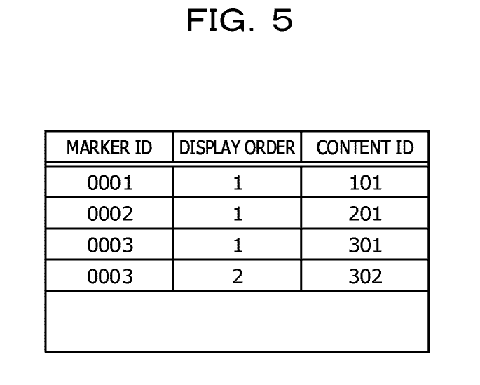

The content-related information 62 is data including information concerning AR contents to be displayed in relation to respective reference objects. The content-related information 62 includes information specifying AR contents to be displayed in relation to an AR marker as a reference object, for example. FIG. 5 is a diagram illustrating an example of the data configuration of the content-related information 62. As illustrated in FIG. 5, the fields of the content-related information 62 include items such as marker IDs, display order, and content IDs. The items of the content-related information 62 illustrated in FIG. 5 are an example, and the content-related information 62 may include another item.

The fields for marker IDs are regions storing identification information of AR markers. The AR markers are given marker IDs as identification information. The fields for marker IDs store marker IDs of AR markers associating the AR contents. The fields for display order are regions storing the order in which AR contents related to each AR marker are displayed. The fields for content IDs are regions storing content IDs of AR contents to be displayed in relation to each AR marker. In the example of FIG. 5, the AR marker with a marker ID of 0001 indicates that the AR content with a content ID of 101 is displayed first (the display order is “1”). The AR marker of a marker ID of 0003 indicates that the AR content with a content ID of 301 is displayed first (the display order is “1”) and the AR content with a content ID of 302 is displayed second (the display order is “2”).

The control unit 52 is a device controlling the display control apparatus 12. The control unit 52 may be an electronic circuit such as a CPU or an MPU or an integrated circuit such as an ASIC or a FPGA. The control unit 52 includes an internal memory configured to store programs prescribing various types of processing procedures and control data and executes various processes using the stored programs and control data. The control unit 52 functions as various types of processing units when various types of programs operate. The control unit 52 includes an image capture control unit 70, a recognition unit 71, a specification unit 72, a modification unit 73, an output unit 74, and a detection unit 75.

The image capture control unit 70 controls the camera 22 of the HMD 11 through the communication I/F unit 50 for image capture. For example, the image capture control unit 70 transmits to the HMD 11, instruction information to instruct image capture at a predetermined frame rate and thereby causes the camera 22 to capture an image at the predetermined frame rate. Image data of the captured image is sequentially transmitted from the HMD 11 and is received with the communication I/F unit 50.

The recognition unit 71 performs various recognition processes. In the captured image, the recognition unit 71 recognizes targets (hereinafter, sometimes referred to as overlay targets) on which AR contents are to be overlaid, for example. The recognition unit 71 executes a process to detect reference objects from the captured image based on the image data received with the communication I/F unit 50, for example. The recognition unit 71 detects AR markers from the captured image represented by the image data, for example. The recognition unit 71 recognizes objects provided with the detected AR markers as overlay targets.

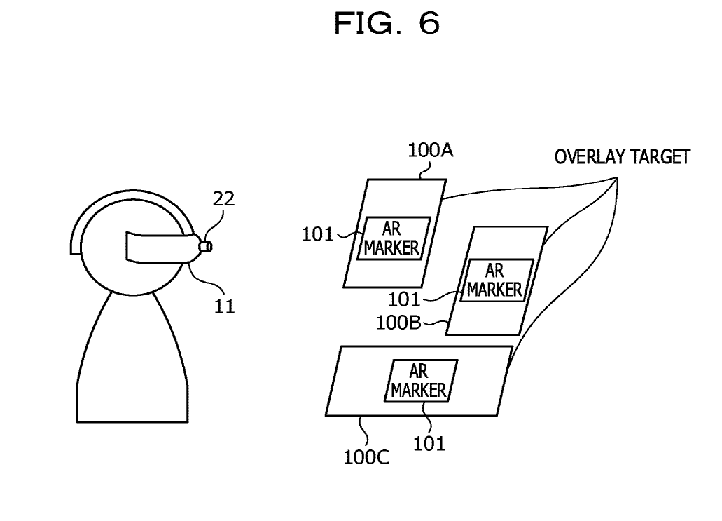

FIG. 6 is a diagram illustrating an example of the process to recognize overlay targets. In the state illustrated in FIG. 6, the user wears the HMD 11 and captures objects 100A to 100C provided with AR markers 101, with the camera 22. The objects 100A to 100C are sheets of paper provided with the AR markers 101, for example. The positions and angles thereof are individually changed. The specification unit 72 detects the AR markers 101 from the captured image represented by image data and recognizes the objects 100A to 100C on which the AR markers 101 are detected, as overlay targets. When the AR markers 101 are detected, the specification unit 72 recognizes the objects 100A to 100C lying in the same plane as the detected AR markers 101 as overlay targets, for example. The specification unit 72 may detect the edge at the periphery of each detected AR marker 101 from the captured image and recognize the range surrounded by the edge of the AR marker 101 as an overlay target. Alternatively, identical AR markers 101 may be provided in advance at a plurality of positions on the boundary of an object on which an AR content is to be overlaid. The specification unit 72 recognizes the range where the identical AR markers 101 are detected as an overlay target. Alternatively, objects on which AR contents are to be overlaid may be of different specific colors or patterns. The specification unit 72 recognizes ranges where the specific colors or patterns are detected as overlay targets.

The specification unit 72 performs various specification processes. When an AR marker is detected, the specification unit 72 specifies an AR content corresponding to the detected AR marker, for example. When an AR marker is detected, the specification unit 72 decodes the pattern image of the detected AR marker to specify a marker ID, for example. Moreover, the specification unit 72 specifies the size of the detected AR marker in the captured image. In accordance with the specified marker ID, the specification unit 72 species an AR content to be displayed. For example, in relation to the specified marker ID, the specification unit 72 specifies the content ID with a display order of 1 from the content-related information 62. The specification unit 72 reads the content data 60 corresponding to the specified content ID from the storage unit 51.

The specification unit 72 specifies the relative positional relationship between the AR contents of specified content IDs in the product. Based on the fields for types in the content information table 61, the specification unit 72 specifies whether the AR content corresponding to each content ID is of a body constituting the product or of a component provided on the body. The specification unit 72 specifies the display style of the AR content corresponding to each specified content ID. The specification unit 72 specifies the display position and size of the AR content based on the AR marker from the fields for display positions and sizes in the content information table 61, for example. The specification unit 72 specifies an operation to which the AR content corresponding to each specified content ID responds. The specification unit 72 specifies whether the AR content corresponding to each specified content ID responds to touch operation based on the fields for operation in the content information table 61, for example.

The modification unit 73 performs various modification processes. For example, the modification unit 73 modifies the image of an AR content of the read content data 60 in accordance with the position, orientation, and size of the corresponding AR marker. The modification unit 73 performs image processing to modify the shape of the image of an AR content in accordance with the position and orientation of the AR marker, for example. The modification unit 73 also changes the display size of the image of an AR content in accordance with the size of the AR marker.

In such circumferences as when the images of AR contents would overlap each other if displayed, the modification unit 73 modifies based on the prescribed order of priority, the shape of an image of lower priority so that an image of higher priority is displayed in preference. In such circumferences as when the image of an AR content of the body would overlap the image of an AR content of a component if displayed, for example, the modification unit 73 modifies the shape of the image of the AR content of the body so that the image of the AR content of the component is displayed in preference. Alternatively, the modification unit 73 modifies the shape of the image of the AR content of the body so that the image of the AR content of the component is displayed on the image of the AR content of the body, for example.

In such circumferences as when the images of AR contents would overlap each other if displayed, the modification unit 73 changes the display size and position of one or both of the images of the AR contents so that the images of the AR contents do not overlap each other. In such circumferences as when images of AR contents of the component would overlap each other if displayed, the modification unit 73 modifies the shape of the image of the AR content so that the images of AR contents of components do not overlap each other, for example. For example, the modification unit 73 changes the display positions and sizes of the images of the AR contents of the components so that the images of the AR contents of the components are displayed at equal size.

The modification unit 73 modifies the shape of the image of each AR content so that the images of the AR contents are displayed as a unit. For example, when there is a gap between the image of an AR content of a body and the image of an AR content of a component, the modification unit 73 modifies the image of the AR content of the body so as to fill the gap. For example, the modification unit 73 extends all of or the boundary of the image of the AR content of the body up to the boundary of the image of the AR content of the component. The modification unit 73 modifies the display style of an image of lower priority in accordance with the display style of the image of higher priority based on the prescribed order. For example, the modification unit 73 modifies the shape of the AR content of the body in accordance with the shape of the AR content of the component. For example, when an AR content of the component is inclined, the modification unit 73 modifies part of the AR content of the body where the inclined AR content of the component is provided to an inclined shape.

The output unit 74 performs various output processes. The output unit 74 outputs to the HMD 11, images of AR contents specified by the specification unit 72 and modified by the modification unit 73, for example. The output unit 74 also generates an image for display in which images of AR contents of AR markers detected from a captured image are overlaid on the captured image, for example. The output unit 74 generates an image for display in which the image of a component that responds to touch operation is overlaid on an object as an overlay target on which the image of the component is to be outputted. Herein, the image of the component is made smaller than the object.

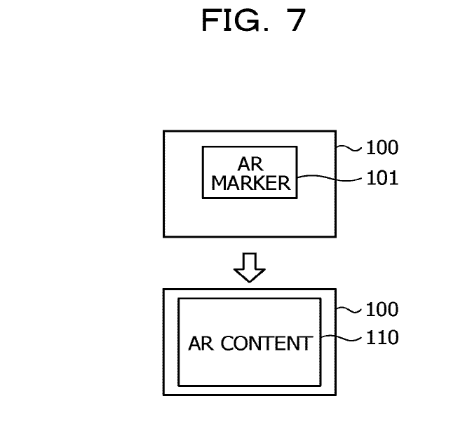

FIG. 7 is a diagram illustrating an example of overlay of an image of a component responding to touch operation. In the example of FIG. 7, an object 100 is a sheet of paper provided with an AR marker 101. The object 100 is a target on which an image 110 of an AR content responding to touch operation is to be outputted. The output unit 74 overlays the image 110 of the AR content so that the image 110 is smaller than the object 100. The image 110 of the AR content responding to touch operation is thus overlaid on the object 100, so that the user performs touch operation by actually touching the object 100.

The output unit 74 transmits image data of the generated image for display to the HMD 11 through the communication I/F unit 50 for display. When the display unit 21 of the HMD 11 has a transmissive lens section so that the user wearing the HMD 11 is allowed to see the external reality environment, the output unit 74 may output the image of the AR content directly to the HMD 11 to display the same through the display unit 21. The display unit 21 overlays the image of the AR content on a transmitted image.

The detection unit 75 performs various detection processes. The detection unit 75 detects user's operation performed for an outputted image, for example. When detecting a hand within a range of an AR content responding to touch operation in the outputted image, the detection unit 75 determines that touch operation is performed. The detection unit 75 may detect touch operation based on the distance between a hand and an overlay target on which an AR content responding to touch operation is displayed. For example, the HMD 11 may be provided with a distance sensor to measure distance in the range captured by the camera 22 and transmits data of the measured distance to the display control apparatus 12 together with the captured image. The detection unit 75 may determine that touch operation is performed when a hand exists within the range of an AR content responding to touch operation and the distance between the hand and an overlay target on which the AR content responding to the touch operation is within a predetermined distance (10 cm, for example).

The modification unit 73 changes the outputted image in accordance with the detected operation. Upon detecting touch operation for the AR content that responds to touch operation, for example, the modification unit 73 outputs the image of the following AR content in the display order, in relation to the AR marker corresponding to the AR content subjected to touch operation.

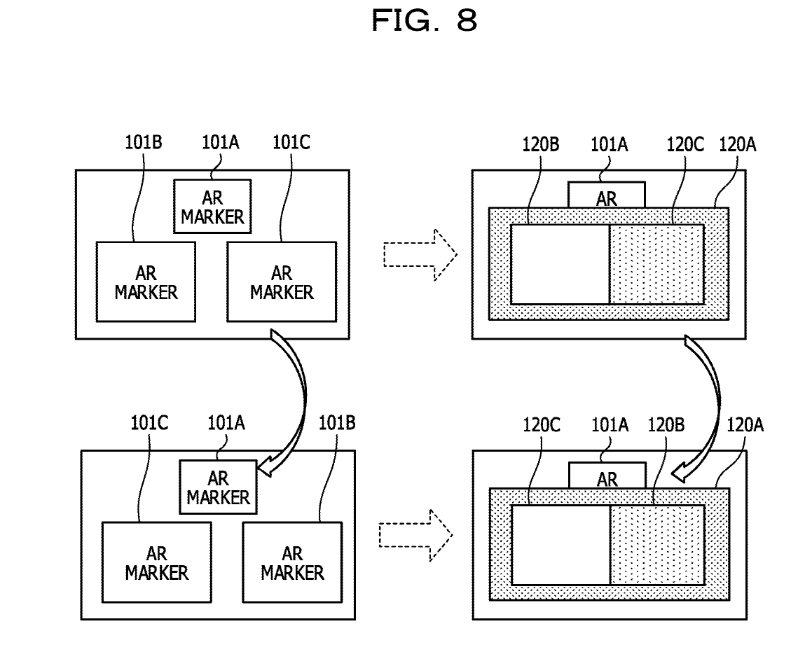

An example of display of AR contents is described. FIG. 8 is a diagram illustrating an example of display of AR contents. In the example of FIG. 8, the captured image includes AR markers 101A to 101C. The AR marker 101A is associated with an AR content of a body 120A of a product. The AR markers 101B and 101C are associated with AR contents of components 120B and 120C constituting the product, respectively. For example, the display control apparatus 12 displays an image in which the AR contents of the body 120A and components 120B and 120C are overlaid, in accordance with the relative positional relationship between the AR markers 101A to 101C in the captured image. For example, the display control apparatus 12 specifies the display positions and sizes of the AR contents of the body 120A and components 120B and 120C based on the AR markers 101A to 101C, respectively and displays an image where the components 120B and 120C are disposed on the body 120A. When the AR markers 101B and 101C are respectively located on the left and right, for example, the display control apparatus 12 displays an image where the components 120B and 120C are located in the left and right sides of the body 120A, respectively. When the AR markers 101B and 101C are respectively located on the right and left, for example, the display control apparatus 12 displays an image where the components 120B and 120C are located in the right and left sides of the AR content of the body 120A, respectively. By changing the positions of the AR markers associated with the components, the user is allowed to easily confirm how the design and usability of the product work if the arrangement of the components is modified.

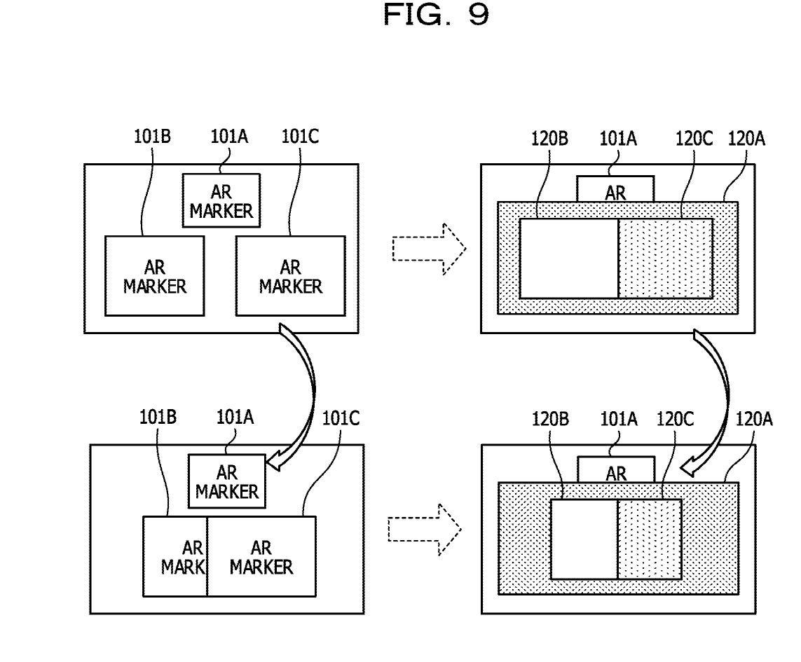

FIG. 9 is a diagram illustrating an example of display of AR contents. In the example of FIG. 9, the captured image includes AR markers 101A to 101C. The AR marker 101A is associated with an AR content of a body 120A of a product. The AR markers 101B and 101C are associated with AR contents of components 120B and 120C constituting the product, respectively. For example, the display control apparatus 12 displays an image in which the AR contents of the body 120A and components 120B and 120C are overlaid in accordance with the relative positional relationship between the AR markers 101A to 101C in the captured image. In such circumferences as when the images of the AR contents would overlap each other if displayed, the display control apparatus 12 changes the display size and position of one or both of the images of the AR contents so that the images thereof do not overlap each other. For example, in such circumferences as when the AR markers 101B and 101C are located close to each other and the AR contents of the components 120B and 120C would overlap each other if displayed, the display control apparatus 12 reduces the display sizes of the AR contents of the components 120B and 120C so that the images of the AR contents of the components 120B and 120C are displayed at equal size. The display control apparatus 12 modifies the shape of the image of each AR content so that the images of the AR contents are integrally displayed as a unit. When the display sizes of the AR contents of the components 120B and 120C are reduced to produce a gap between the image of the AR content of the body 120A and the images of the AR contents of the components 120B and 120C, the modification unit 73 modifies the image of the AR content of the body 120A so as to fill the gap.

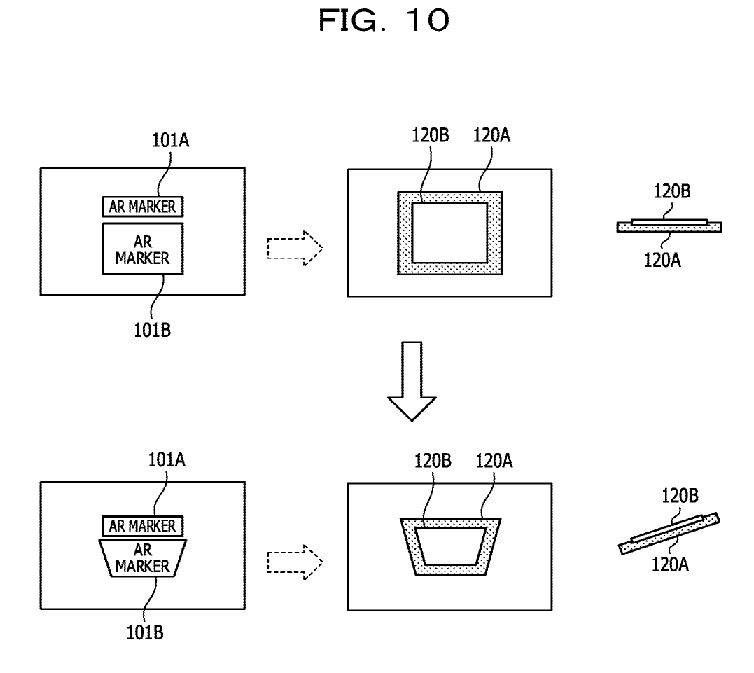

FIG. 10 is a diagram illustrating an example of display of AR contents. In the example of FIG. 10, the captured image includes AR markers 101A and 101B. The AR marker 101A is associated with an AR content of a body 120A of a product. The AR marker 101B is associated with an AR content of a component 120B constituting the product. For example, the display control apparatus 12 displays an image where the AR contents of the body 120A and component 120B are overlaid in accordance with the relative positional relationship between the AR markers 101A and 101B in the captured image. The display control apparatus 12 modifies the shape of the image of each AR content so that the images of the AR contents are displayed as a unit. For example, the display control apparatus 12 modifies the shape of the AR content of the body 120A in accordance with the shape of the AR content of the component 120B. When neither the AR markers 101A nor 101B are inclined, for example, the display control apparatus 12 displays the body 120A and component 12B without inclining the same. When the AR marker 101B is inclined while the AR marker 101A is not inclined, the display control apparatus 12 displays the AR content of the component 120B at an angle and similarly displays the AR content of the body 120A at an angle.

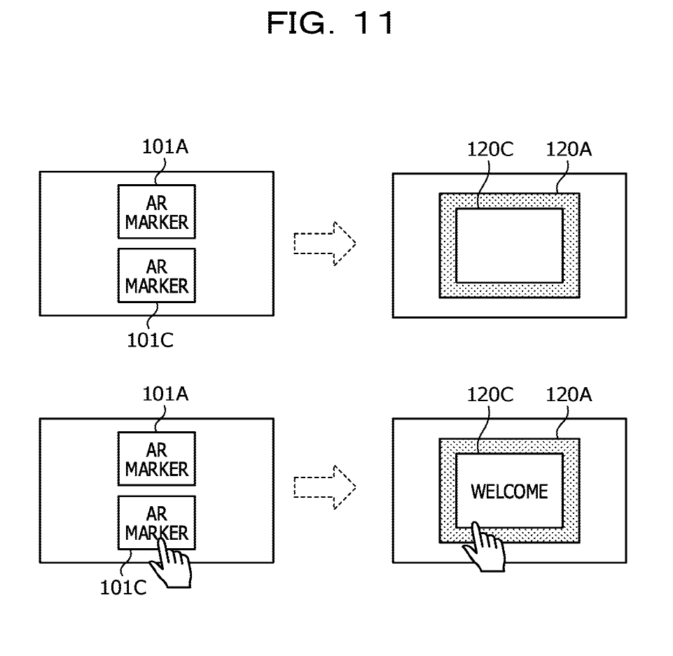

FIG. 11 is a diagram illustrating an example of display of AR contents. In the example of FIG. 11, the captured image includes AR markers 101A and 101C. The AR marker 101A is associated with an AR content of a body 120A of a product. The AR marker 101C is associated with an AR content of a component 120C constituting the product. The AR content of the component 120C responds to touch operation. For example, the display control apparatus 12 displays an image where the AR contents of the body 120A and component 120C are overlaid in accordance with the relative positional relationship between the AR markers 101A and 101C in the captured image. The display control apparatus 12 changes the outputted image in accordance with the detected operation. For example, when touch operation for the AR content of the component 120C is detected, the display control apparatus 12 changes the image corresponding to the AR marker 101C to an image of the following AR content in the display order.

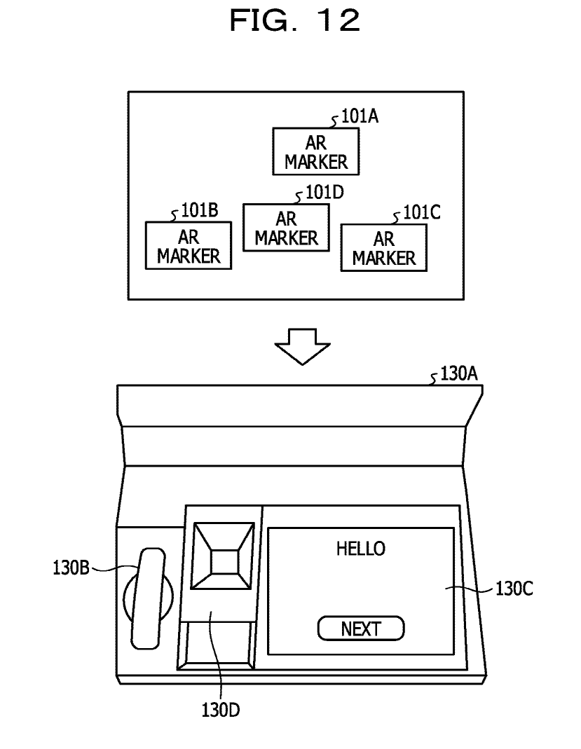

Next, an example of evaluation of design usability, herein of a bank automated teller machine (ATM), is described. FIGS. 12 to 14 are diagrams illustrating an example of the flow to evaluate design usability. In the example of FIG. 12, the captured image includes AR markers 101A to 101D. The AR marker 101A is associated with an AR content of a body 130A of the ATM. The AR marker 101B is associated with an AR content of a talking unit 130B. The AR marker 101C is associated with an AR content of an operation panel 130C. The AR content of the operation panel 130C responds to touch operation. The AR marker 101D is associated with an AR content of a reading unit 130D which scans the palm vein pattern. When the AR markers 101B, 101D, and 101C are arranged side by side in the horizontal direction in that order, for example, the display control apparatus 12 displays and overlays an image where the AR contents of the talking unit 130B, reading unit 130D, and operation panel 130C are arranged side by side on the AR content of the body 130A of the ATM in accordance with the relative positional relationship between the AR markers 101B, 101C, and 101D in the captured image.

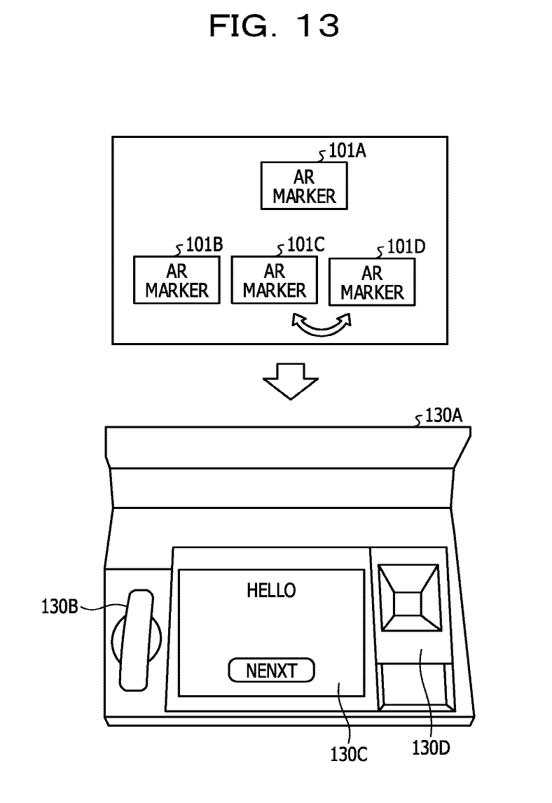

For example, the user switches the AR markers 101C and 101D to confirm the usability where the reading unit 130D and operation panel 130C are switched. In the example of FIG. 13, the AR markers 101B, 101C, and 101D are arranged side by side in the horizontal direction in that order. In this case, the display control apparatus 12 displays and overlays an image where the AR contents of the talking unit 103B, operation panel 130C, and reading unit 130D are arranged side by side in the horizontal direction on the AR content of the body 130A of the ATM.

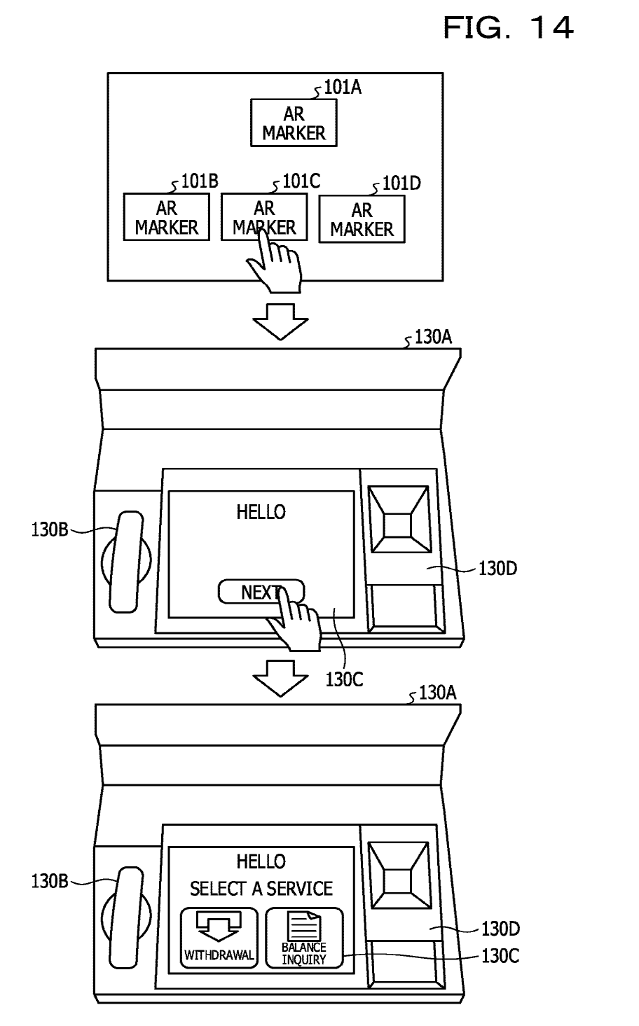

For example, the user performs touch operation for the operation panel 130C to confirm the usability at operating the operation panel 130C. In the example of FIG. 14, touch operation is performed for the AR content of the operation panel 130C corresponding to the AR marker 101C. When it is detected that touch operation is performed for the AR content of the operation panel 130C, the display control apparatus 12 changes the image of the AR content of the operation panel 130C. In such a manner, the display control apparatus 12 expresses changes in design varying in accordance with the real arrangement of components.

[Processing Flow]

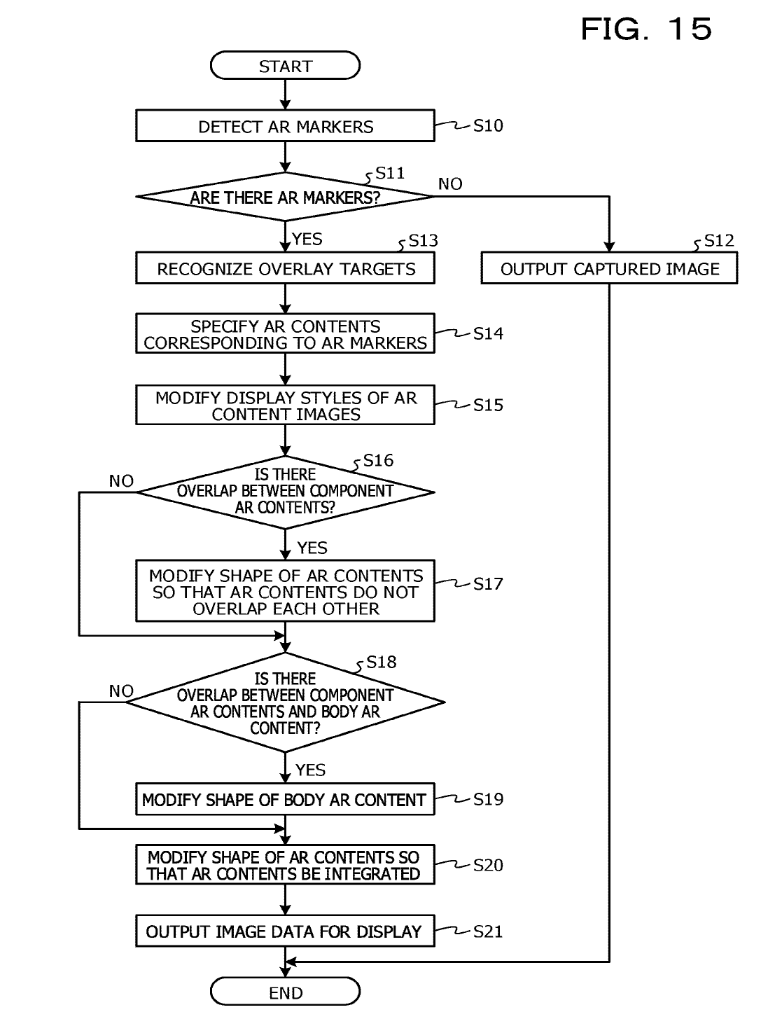

Next, a flow of a display control process executed by the display control apparatus 12 according to the first embodiment is described. FIG. 15 is a flowchart illustrating an example of the procedure of the display control process. The display control process is executed at a predetermined time, that is, each time the display control apparatus 12 receives image data of a captured image from the HMD 11, for example.

As illustrated in FIG. 15, the recognition unit 71 performs detection of AR markers for the captured image represented by the image data (S10). The recognition unit 71 determines whether AR markers are detected (S11). When any AR marker is not detected (No in S11), the output unit 74 outputs the image data of the captured image to the HMD 11 (S12) and terminates the process.

On the other hand, when AR markers are detected (Yes in S11), the recognition unit 71 recognizes objects with the AR markers detected as overlay targets (S13). The specification unit 72 specifies AR contents corresponding to the respective detected AR markers (S14). The modification unit 73 modifies images of the AR contents into display styles corresponding to the positions, orientations, and sizes of the respective AR markers (S15).

The modification unit 73 determines whether an overlap occurs between the images of the AR contents of components (S16). When no overlap occurs (No in S16), the process proceeds to S18 described later.

On the other hand, when the overlap occurs (Yes in S16), the modification unit 73 modifies the shape of at least one of the images of the AR contents so that the images of the AR contents of the components do not overlap each other (S17).

The modification unit 73 determines whether an overlap occurs between the image of the AR content of each component and the image of the AR content of a body (S18). When no overlap occurs (No in S18), the process proceeds to S20 described later.

On the other hand, when the overlap occurs (Yes in S18), the modification unit 73 modifies the shape of the image of the AR content of the body so that the images of the AR contents of the components be displayed on the image of the AR content of the body (S19).

The modification unit 73 modifies the shape of the image of each AR content so that the images of the AR contents be displayed as a unit (S20). The output unit 74 generates an image for display in which the modified images of the AR contents are overlaid on the captured image and outputs image data of the generated image for display to the HMD 11 (S21). The process is then terminated.

### Effects

As described above, the display control apparatus 12 captures an image of first identification information (an AR marker, for example) provided on a first component and an image of second identification information (an AR marker, for example) provided on a second component. With reference to the storage unit 23 storing a plurality of pieces of identification information and images in accordance with the relative positional relationship between the plurality of pieces of identification information, the display control apparatus 12 specifies images in accordance with the captured images of the first identification information and second identification information. The display control apparatus 12 outputs the specified images. The display control apparatus 12 therefore expresses changes in designs varying in accordance with the real component arrangement. With the display control device 12, the user therefore evaluates the design usability without producing a mock-up.

The display control apparatus 12 specifies a first image corresponding to the first identification information and a second image corresponding to the second identification information. In such circumferences as when the first and second images would overlap each other if displayed, the display control apparatus 12 changes the display size and position of one or both of the first and second images so that the first and second images do not overlap each other. The display control apparatus 12 outputs the modified first and second images. Even in such a circumference as when the first and second images would overlap each other if displayed by moving the positions of the first and second identification information, for example, the display control apparatus 12 displays the first and second images with improved visualization.

Moreover, the display control apparatus 12 specifies a first image corresponding to the first identification information and a second image corresponding to the second identification information. In such circumferences as when the first and second images would overlap each other if displayed, the display control apparatus 12 modifies the shape of one of the first and second images having lower priority in the prescribed order of priorities so that the image of higher priority is displayed in preference. The display control apparatus 12 outputs the modified first and second images. Even when the first and second images overlap each other, the display control apparatus 12 displays an image of higher priority with improved visualization.

Furthermore, the display control apparatus 12 detects user's operation for the outputted image. The display control apparatus 12 changes the outputted image in accordance with the detected operation. The display control apparatus 12 thus allows pseudo operation for the product being designed. The user therefore evaluates the design usability through actual touch.

Still furthermore, at outputting an image of a component that responds to touch operation, the display control apparatus 12 makes the image of the component that responds to touch operation smaller than the object corresponding to the target on which the same component is to be outputted. The display control apparatus 12 therefore allows the user to perform touch operation by actually touching components that respond to touch operation.

Still furthermore, the display control apparatus 12 stores in the storage unit 51, an image of a body constituting the product and an image of a component constituting the product in association with the first identification information and second identification information, respectively. The display control apparatus 12 outputs an image in which the images of the body of the product and the component constituting the product are overlaid as a unit in accordance with the relative positional relationship between the first identification information and second identification information. The display control apparatus 12 therefore allows the user to recognize the body and component constituting the product as a unit in the outputted image.

### Embodiment 2

Hereinabove, the embodiment related to the disclosed apparatus is described. The disclosed technique may be implemented in various different modes other than the aforementioned embodiment. Other embodiments are described below.

For example, it is set whether each AR content responds to an operation in the aforementioned example of Embodiment 1. However, this embodiment is not limiting. For example, it is possible to set a range that responds to an operation in each AR content. In the case where a plurality of buttons, such as buttons of a numeric keypad and operation buttons, are displayed as AR contents, for example, the range of each button is set as the range that responds to an operation. The AR content to be displayed next is set for each range. As for a numeric keypad, the display control apparatus 12 previously sets a range that responds to an operation for each button of the numeric keypad. When one of the ranges that respond to an operation is subjected to the operation, the display control apparatus 12 displays the numeral of the button corresponding to the range that is subjected to the operation, on an image of the AR content corresponding to the display unit of the product.

In the aforementioned example of Embodiment 1, the display control apparatus 12 detects AR markers and overlays AR contents. However, the disclosure is not limited to this. For example, the HMD 11 may be configured to detect AR markers and overlay AR contents. The function of the HMD 11 may be implemented by a head-mounted adaptor that accommodates a smartphone as the display unit.

In the aforementioned example of Embodiment 1, the display priorities are determined depending on the element types. However, the disclosure is not limited to this. For example, priority may be given to respective images of AR contents of the body and components. The image control apparatus modifies the shapes of images of AR contents of lower priority so that the images of AR contents of higher priority be displayed in preference.

The constituent elements of each apparatus illustrated in the drawings are functionally conceptual and may not to be physically configured as illustrated in the drawings. The specific distribution and integration of each apparatus are not limited to the illustrations in the drawings. All or some of the constituent elements may be functionally or physically distributed or integrated on any unit basis in accordance with the various types of loads and usage situations. For example, the processing units including the image capture control unit 70, recognition unit 71, specification unit 72, modification unit 73, output unit 74, and detection unit 75 may be properly integrated or divided. All or some of the processing functions performed by the processing units may be implemented by a CPU and programs analyzed and executed by the CPU or may be implemented in hardware by a wired logic.

[Display Control Program]

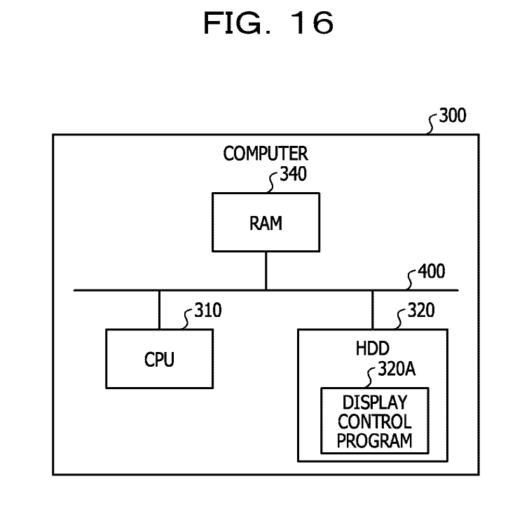

The various types of processes described in the above embodiments may be implemented by executing prepared programs in a computer system such as a personal computer or a workstation. An example of the computer system that executes a program including the same functions as those of the aforementioned embodiments is described below. FIG. 16 is a diagram illustrating a computer executing a display control program.

As illustrated in FIG. 16, a computer 300 includes a CPU 310, a hard disk drive (HDD) 320, and a random access memory (RAM) 340. The CPU 310, HDD 320, and RAM 340 are connected through a bus 400.

The HDD 320 previously stores a display control program 320A exerting the same functions as those of the processing units of the above-described embodiments. For example, the display control program 320A exerts the same functions as those of the image capture control unit 70, recognition unit 71, specification unit 72, modification unit 73, output unit 74, and detection unit 75 of the aforementioned embodiments, for example. The display control program 320A may be properly divided.

The HDD 320 further stores various types of data. For example, the HDD 320 stores the OS or various types of data.

The CPU 310 reads the display control program 320A from the HDD 320 and executes the display control program 320A to implement the same operations as those of the image capture control unit 70, recognition unit 71, specification unit 72, modification unit 73, output unit 74, and detection unit 75 of the embodiments. In other words, the display control program 320a executes the same operations as those of the image capture control unit 70, recognition unit 71, specification unit 72, modification unit 73, output unit 74, and detection unit 75 of the embodiments.

The aforementioned display control program 320A may not to be originally stored in the HDD 320. The display control program may be stored in a portable physical medium to be inserted into the computer 300, such as a flexible disk (FD), a compact disk read only memory (CD-ROM), a digital versatile disk (DVD), a magneto-optical disk, or an IC card, for example. The computer 300 is configured to read the display control program stored in the portable physical medium and execute the read display control program.

Moreover, the display control program may be stored in another computer (or a server) connected to the computer 300 through a public line, the Internet, a LAN, or a WAN. The computer 300 is configured to read the display control program stored in another computer and execute the read display control program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method executed by a computer, the method comprising:
detecting a plurality of reference objects from an image;
specifying identification information corresponding to each of the plurality of reference objects;
acquiring a plurality of contents corresponding to the respective identification information;
virtually arranging the plurality of contents based on position information of each of the plurality of contents, the position information being set with reference to the plurality of reference objects respectively;
determining whether an overlap occurs between display regions of at least some contents among the plurality of contents virtually arranged;
when the overlap occurs, changing at least one of a display size and a position of the at least some contents overlapping each other to remove the overlap;
generating display data for displaying another image including the plurality of contents based on at least one of the changed display size and the changed position of the at least some contents, and the position information of contents other than the at least some contents; and
controlling a display to display the another image based on the display data.

2. The method according to claim 1, wherein the plurality of reference objects is objects which are different from each other.

3. The method according to claim 2, wherein the objects is movable objects, respectively.

4. The method according to claim 3, wherein
the plurality of reference objects are AR markers, and
the AR markers have different identification information, respectively.

5. The method according to claim 1, wherein the plurality of contents are AR contents.

6. The method according to claim 5, wherein the plurality of contents include an AR content representing a shape of a body of a product and another AR content representing a shape of a component included in the product.

7. The method according to claim 6, wherein the image data for display is data for AR display of the product including the body and the component.

8. The method according to claim 7, wherein the display data corresponds to a composite image of the product including plurality of contents as a unit.

9. The method according to claim 1, wherein the generating of the display data includes:
when at least two contents are associated with a first identification information corresponding to a first reference object among the plurality of reference objects, specifying a first content of higher priority based on the order of priorities previously set for the at least two contents, and
generating the display data including the first content and a content corresponding to identification information other than the first identification information.

10. The method according to claim 9, further comprising:
specifying a second content among the at least two contents when accepting a predetermined operation for the first content after displaying based on the display data;
generating new display data including the second content and a content corresponding to identification information other than the first identification information; and
controlling the display to display new image based on new display data.

11. The method according to claim 10, wherein the predetermined operation is a touch operation to the first reference object which has the first identification information corresponding to the first content.

12. The method according to claim 1, wherein
the computer is a terminal device to be held,
the display is a head mounted display to be worn,
the head mounted display and the terminal device are capable of communicating with each other wirelessly, and
the image is taken by a camera included in the head mounted display.

13. A device comprising:
a memory; and
a processor coupled to the memory and configured to:
detect a plurality of reference objects from an image,
specify identification information corresponding to each of the plurality of reference objects,
acquire a plurality of contents corresponding to the respective identification information,
virtually arrange the plurality of contents based on position information of each of the plurality of contents, the position information being set with reference to the plurality of reference objects respectively,
determine whether an overlap occurs between display regions of at least some contents among the plurality of contents virtually arranged,
when the overlap occurs, change at least one of a display size and a position of the at least some contents overlapping each other to remove the overlap,
generate display data for displaying another image including the plurality of contents based on at least one of the changed display size and the changed position of the at least some contents, and the position information of contents other than the at least some contents, and
control a display to display the another image based on the display data.

14. The device according to claim 13, wherein
the plurality of reference objects are AR markers, and
the AR markers have different identification information, respectively.

15. The device according to claim 13, wherein the plurality of contents are AR contents.

16. The device according to claim 15, wherein the plurality of contents include an AR content representing a shape of a body of a product and another AR content representing a shape of a component included in the product.

17. The device according to claim 16, wherein the image data for display is data for AR display of the product including the body and the component.

18. The device according to claim 17, wherein the display data corresponds to a composite image of the product including plurality of contents as a unit.

19. The device according to claim 13, wherein
the device is a terminal device to be held,
the display is a head mounted display to be worn,
the head mounted display and the terminal device are capable of communicating with each other wirelessly, and
the image is taken by a camera included in the head mounted display.

20. A non-transitory computer-readable storage medium storing a program that causes a computer to execute a process, the process comprising:
detecting a plurality of reference objects from an image;
specifying identification information corresponding to each of the plurality of reference objects;
acquiring a plurality of contents corresponding to the respective identification information;
virtually arranging the plurality of contents based on position information of each of the plurality of contents, the position information being set with reference to the plurality of reference objects respectively;
determining whether an overlap occurs between display regions of at least some contents among the plurality of contents virtually arranged;
when the overlap occurs, changing at least one of a display size and a position of the at least some contents overlapping each other to remove the overlap;
generating display data for displaying another image including the plurality of contents based on at least one of the changed display size and the changed position of the at least some contents, and the position information of contents other than the at least some contents; and
controlling a display to display the another image based on the display data.
